(19) United States
(12) Patent Application Publication
(10) Pub. No.: US 2016/0025910 A1
(43) Pub. Date: Jan. 28, 2016

(54) METHOD FOR PRODUCING POLARIZER

(71) Applicant: NITTO DENKO CORPORATION, Osaka (JP)

(72) Inventors: Hiroaki SAWADA, Osaka (JP); Takeharu Kitagawa, Osaka (JP); Takashi Kamijo, Osaka (JP)

(21) Appl. No.: 14/874,028

(22) Filed: Oct. 2, 2015

Related U.S. Application Data
(63) Continuation-in-part of application No. 13/318,415, filed on Nov. 1, 2011.

(30) Foreign Application Priority Data
May 1, 2009 (JP) 2009-111678
May 20, 2009 (JP) 2009-122365
Apr. 26, 2010 (JP) 2010-100528

(51) Int. Cl. G02B 5/30

(52) U.S. Cl. CPC G02B 5/305

(57) ABSTRACT

A method for producing a polarizer comprises the steps of: (A) forming a polyvinyl alcohol-based resin layer on a support made of an optically transparent thermoplastic resin; (B) stretching a polyvinyl alcohol-based resin layer together with the support to obtain a stretched layer; (C) immersing the stretched layer in a dyeing liquid containing iodine to obtain a dyed layer in which absorbance thereof determined from a tristimulus value Y is from 0.4 to 1.0 (transmittance T=40% to 10%); and (D) removing a part of iodine adsorbed in the dyed layer so that the absorbance of the dyed layer decreases by 0.03 to 0.7, provided that the absorbance of the dyed layer is controlled so that it does not become less than 0.3. The support may be used as an optical film laminated to the polarizer.

### BACKGROUND OF THE INVENTION

1. Field of the Invention

The present invention relates to a method for producing a polarizer provided on a support and including a polyvinyl alcohol-based resin layer containing iodine. The present invention further relates to a laminate of optical films including a polarizer comprising a polyvinyl alcohol-based resin layer and a support including a layer of an optically transparent resin.

2. Description of Related Art

There has been known a production method in which a polyvinyl alcohol film is dyed with a dyeing liquid containing iodine and then stretched to obtain a polarizer (for example, JP-A-2003-270440). In the above-mentioned production method, the thus dyed and stretched film is subjected to an iodine ion impregnation treatment by immersing in an aqueous potassium iodide solution, and then subjected to an alcohol liquid immersion treatment by immersing in an alcohol liquid.

The polarizer obtained by this production method exhibits less yellowness and is less likely to cause a change in color hue even under a heating environment. The reason why the polarizer exhibits less yellowness is that absorbance thereof is nearly constant in the entire wavelength range of visible light.

However, the above-mentioned polarizer has a problem such as a low polarization degree.

### SUMMARY OF THE INVENTION

There has been known, as a method of obtaining a polarizer, a method in which a polyvinyl alcohol film is dyed with a dyeing liquid containing iodine, stretched, subjected to an iodine ion impregnation treatment by immersing in an aqueous potassium iodide solution, and then subjected to an alcohol liquid immersion treatment by immersing in an alcohol liquid. However, the polarizer obtained by this production method has a problem such as a low polarization degree.

The present invention provides a production method capable of obtaining a polarizer including a polyvinyl alcohol-based resin layer containing iodine, which has a high polarization degree.

The summary of the present invention is as follows:

In a first preferred aspect of the present invention, there is provided a method for producing a polarizer formed on an optically transparent thermoplastic resin support, wherein the polarizer includes a polyvinyl alcohol-based resin layer, and containing iodine. The method comprises steps of:

(A) forming a polyvinyl alcohol-based resin layer on a support made of an optically transparent thermoplastic resin;

(B) stretching the polyvinyl alcohol-based resin layer together with the support to obtain a laminate of a stretched polyvinyl alcohol-based resin layer and a stretched support;

(C) immersing the laminate of the stretched polyvinyl alcohol-based resin layer and the stretched support in a dyeing liquid containing iodine to obtain a dyed polyvinyl alcohol-based resin layer in which absorbance thereof determined from a tristimulus value Y is from 0.4 to 1.0 (transmittance T=40% to 10%); and

(D) removing a part of iodine adsorbed to the dyed polyvinyl alcohol-based resin layer so that the absorbance of the dyed layer decreases by 0.03 to 0.7, provided that the absorbance of the dyed layer is controlled so that it does not become less than 0.3.

In the method, it is preferable that the stretched polyvinyl alcohol-based resin layer has a layer thickness of 0.4 μm to 7 μm.

In a preferred aspect of the method according to the present invention, the support is made of a material having at least one of a reflecting property, a light scattering property, a hue adjusting function, an antistatic function, an anisotropic scattering polarization property or an anti-blocking function. In a further preferable aspect of the present invention, the support is made of a material selected from a group including ester-based resin; cycloolefin-based resin; olefin-based resin; polyamide-based resin; polycarbonate-based resin; a copolymer resin thereof; and a blended polymer resin thereof.

According to a further aspect, the present invention provides a laminate of at least two optical films, including a polarizer comprising a stretched layer of polyvinyl alcohol-based resin including iodine adsorbed therein, and a support including a layer of an optically transparent resin. The layer of polyvinyl alcohol-based resin has a thickness of 0.4 to 7 μm and includes polymer chains oriented substantially in one direction, said polymer chain including a highly oriented crystallized portion. The iodine adsorbed in said layer of polyvinyl alcohol-based resin is present in the layer of polyvinyl alcohol-based resin in the form of polyiodine ion complex adsorbed to the crystallized portion of the layer of polyvinyl alcohol-based resin to provide the polarizer with a dichroic property, whereby the polarizer exhibits an absorbance of 0.359 to 0.380 and a polarization degree of 99.9% or higher.

In a preferable aspect, the polarizer exhibits an absorbance of 0.362 to 0.377 and a polarization degree of 99.9% or higher. It is also preferable that the support is made of a material having at least one of a reflecting property, a light scattering property, a hue adjusting function, an antistatic function, an anisotropic scattering polarization or an anti-blocking function. In such a case, the support may be made of a material selected from a group including ester-based resin; cycloolefin-based resin; olefin-based resin; polyamide-based resin; polycarbonate-based resin; a copolymer resin thereof; and a blended polymer resin thereof.

In another preferable aspect, the present invention provides a laminate of at least two optical films, including a polarizer comprising a stretched layer of polyvinyl alcohol-based resin including iodine adsorbed therein, and a support including a layer of an optically transparent resin. The layer of polyvinyl alcohol-based has a thickness of 0.4 to 7 μm and includes polymer chains oriented substantially in one direction. The polymer chain includes a highly oriented crystallized portion. The iodine adsorbed in said layer of polyvinyl alcohol-based resin is present in the layer of polyvinyl alcohol-based resin in the form of polyiodine ion complex adsorbed to the crystallized portion of the layer of polyvinyl alcohol-based resin to provide the polarizer with a dichroic property, whereby the polarizer exhibits an absorbance of 0.377 or less and a polarization degree of 99.95% or higher.

Preferably, the polarizer exhibits an absorbance of 0.362 to 0.377 and a polarization degree of 99.95% or higher. It is further preferable that the polyiodine ion complex is adsorbed to the crystallized portion of the polymer chain in the form of I₃⁻ or I₅⁻.

The support may be made of a material having at least one of a reflecting property, a light scattering property, a hue adjusting function, an antistatic function, an anisotropic scattering polarization or an anti-blocking function. Further, the support may be made of a material selected from a group including ester-based resin; cycloolefin-based resin; olefin-based resin; polyamide-based resin; polycarbonate-based resin; a copolymer resin thereof; and a blended polymer resin thereof. As a material having at least one of a reflecting property, a light scattering property, a hue adjusting function, an antistatic function, an anisotropic scattering polarization or an anti-blocking function, a laminate of two or more transparent resin layers may be used. Such a laminate may for example comprise a transparent resin base layer and a second transparent layer laminated to the base layer, the second layer being of a material having a refractive index n₁ which is lower than that of the material of the base layer. In this case, the second layer may have an initial thickness which is determined such that the thickness d after stretching will have a value satisfying the relationship d=(¼)×(λ/n₁) which represents a condition for allowing the second layers function as an anti-reflection film, where represents a wavelength of light which may preferably be 550 nm for the purpose of preventing reflection. The second layer functions after stretching as an anti-reflection film so that even when polyester film having a refractive index n₁ of 1.58 is used as the base layer, it is possible to suppress a surface reflection to an extent equivalent to a case of tri-acetyl-cellulose which has a refractive index of 1.49 and has commonly been used as a protective film for a polarizer. Thus, by using such a laminate, it is possible to suppress a decrease in transmission rate.

Alternatively, a transparent resin film may be provided by a transparent base resin layer having a plurality of domains of a different transparent resin material dispersed in the base resin layer in such a manner that the resin film possesses at least one of the aforementioned optical properties when the base resin layer and the domains of the different transparent resin material have been stretched according to the process described herein. Such a film may comprise a transparent base resin layer and a plurality of dispersed domain resin material which has refractive index after stretching coinciding with that of the base resin layer after stretching in a direction transverse to the direction of stretching. Such a film can be effective to enhance the polarization degree in a manner described in the U.S. Patent Application Publication 2001/0004299 A1. Alternatively, a film shown in JP H9-274108 may also be used as the support. Such a film shows an anisotropic scattering polarization property when stretched with the PVA-based resin layer. Another example is the one shown and described in the U.S. Pat. No. 5,825,543 issued on Oct. 20, 1998 to A. J. Ouderkirk et. al.

The present inventors have intensively studied so as to achieve the above-mentioned object and found that a polarizer having a high polarization degree is obtained by sequentially carrying out the following steps A to D. The respective steps will be described with reference to FIGS. 1 and 2. FIGS. 1 and 2 show the case where a polyvinyl alcohol-based resin layer is formed on a support and the polyvinyl alcohol-based resin layer is stretched together with the support.

### [Step A] Forming a Polyvinyl Alcohol Layer on a Support

First, a longitudinally extending web of an optically transparent thermoplastic resin or a blended polymer resin thereof is prepared as a support. Then, a solution of polyvinyl alcohol-based resin is coated on one surface of the support made of the optically transparent thermoplastic resin to thereby form a polyvinyl alcohol-based resin layer on the support.

FIG. 1(a) is a schematic sectional view of a polyvinyl alcohol-based resin layer 10 before stretching formed on a support 30. The polyvinyl alcohol-based resin layer 10 is composed of an amorphous portion 11 and a crystallized portion 12. The crystallized portion 12 exists at random in the amorphous portion 11. Arrow 13 shows a stretch direction in the subsequent step. The support may be made of a thermoplastic resin. The thermoplastic resin support may be of any material capable of being stretched integrally with the PVA-based resin layer during stretching, and may have a single layer structure, or a multi-layer laminate structure formed by laminating a plurality of layers made of a single polymeric material or at least two or more types of polymeric materials. The polymeric material may be a homopolymer or a copolymer, or may be a blended polymer. Further, the polymeric material may contain therein a component made of an inorganic material and/or an organic material and added thereto. The substrate may be formed using a material with an optical property or function such as a reflecting property, a light scattering property or a hue adjusting function, or other function such as an antistatic function, an anisotropic scattering polarization property or an anti-blocking function, in such a manner as to allow the substrate in a stretched state to be used as an optical film, together with the polarizer formed of the PVA-based resin layer after stretching. Further, with a view to further enhancing adhesiveness between the substrate and the PVA-based resin layer, an adhesion facilitating layer may be applied onto the substrate, or a material capable of assisting the adhesiveness may be added into the polymeric material. Examples of a material for forming the thermoplastic resin support include: an ester-based resin such as a polyethylene terephthalate-based resin; a cycloolefin-based resin; an olefin-based resin such as polypropylene; a polyamide-based resin; a polycarbonate-based resin; a copolymer resin thereof; or a blended polymer resin thereof.

### [Step B] Stretching Before Dyeing

First, the polyvinyl alcohol-based resin layer 10 is stretched together with a support 30. The polyvinyl alcohol-based resin layer 10 is referred to as a stretched layer 14 after stretching. FIG. 1(b) is a schematic sectional view of the stretched layer 14. A first point in the production method of the present invention is that the polyvinyl alcohol-based resin layer 10 is stretched before dyeing. Arrow 15 shows a stretch direction. A polymer chain (not shown) in the stretched layer 14 is crystallized by stretching to form a crystallized portion 17 having higher orientation property in an amorphous portion 16.

### [Step C] Excessive Dyeing

Then, the stretched layer 14 is dyed. Dyeing is an adsorption treatment of iodine. The stretched layer 14 is referred to as a dyed layer 18 after dyeing. FIG. 2(c) is a schematic sectional view of the dyed layer 18. A second point in the production method of the present invention is that the stretched layer 14 is immersed in a dyeing liquid containing iodine and excessively dyed. Excessive dyeing means that dyeing is carried out so that an absorbance A_{c} determined from a tristimulus value Y becomes 0.4 or more. A subscript C of the absorbance A_{c} represents the step C.

A common polarizer has an absorbance A, which is determined from the tristimulus value Y, of about 0.37. For example, a polarizer with a transmittance T of 43% has an absorbance A of 0.367. Therefore, it is supposed that dyeing which enables an absorbance A_{c} of 0.4 or more, like dyeing in the present invention, is excessive dyeing.

The crystallized portion 17 of the polymer chain is not easily dyed as compared with the amorphous portion 16. However, it is also possible to sufficiently adsorb iodine to the crystallized portion 17 by excessively dyeing the stretched layer 14. The adsorbed iodine forms a polyiodine ion complex 19 of I₃⁻ or I₅⁻ or the like in the dyed layer 18. The polyiodine ion complex 19 exhibits absorption dichroism in a visible light range (wavelength of 380 nm to 780 nm).

### [Step D] Decolorization (Partial Removal of Iodine)

Next, a part of iodine adsorbed to the dyed layer 18 is removed. This operation is referred to as decolorization. The dyed layer 18 is referred to as a polarizer 20 after decolorization. The iodine is adsorbed to the dyed layer 18 in the form of the polyiodine ion complex 19. FIG. 2(d) is a schematic sectional view of the polarizer 20. A third point in the production method of the present invention is that a part of the polyiodine ion complex 19 is removed from the excessively dyed layer 18. In order to remove the polyiodine ion complex 19 from the dyed layer 18, for example, the dyed layer 18 is immersed in an aqueous potassium iodide solution (decolorization liquid). At this time, the polyiodine ion complex 19 is removed so that the absorbance A_{C} decreases by 0.03 to 0.7, provided that the absorbance of the dyed layer is controlled so that it does not become less than 0.3. A subscript D of the absorbance A_{D} represents the step D.

When the polyiodine ion complex 19 is removed, the polyiodine ion complex 19 adsorbed to the amorphous portion 16 is preferentially removed. As a result, the polyiodine ion complex 19 adsorbed to the crystallized portion 17 remains in a relatively large amount.

The polyiodine ion complex 19 adsorbed to the amorphous portion 16 slightly contributes to absorption dichroism. On the other hand, the polyiodine ion complex 19 adsorbed to the crystallized portion 17 largely contributes to absorption dichroism. However, the polyiodine ion complex 19 adsorbed to the amorphous portion 16 and the polyiodine ion complex 19 adsorbed to the crystallized portion 17 increase the absorbance, in the same way. According to the production method of the present invention, it is possible to preferentially remove the polyiodine ion complex 19 adsorbed to the amorphous portion 16, which increases the absorbance regardless of small contribution to absorption dichroism. Therefore, the amount of the polyiodine ion complex 19 adsorbed to the crystallized portion 17, which largely contributes to absorption dichroism, relatively increases. Large contribution to absorption dichroism means a high polarization degree. Thus, according to the production method of the present invention, it is possible to obtain a polarizer 20 having a high polarization degree regardless of low absorbance.

The present invention further provides a method for producing an optical display device including a polarizer formed on an optically transparent thermoplastic resin support. According to the method, the polarizer formed on the optically transparent thermoplastic resin support produced with the aforementioned method including the steps (A), (B), (C) and (D) is assembled after the step (D) in the display device by attaching the polarizer together with the support to an optical display panel.

### Advantage of the Invention

According to the production method of the present invention, the amount of the polyiodine ion complex 19 adsorbed to the crystallized portion 17, which largely contributes to absorption dichroism, increases, thus obtaining a polarizer 20 having a high polarization degree regardless of low absorbance.

### BRIEF DESCRIPTION OF THE DRAWINGS

FIG. 1(a) is a schematic view showing a polyvinyl alcohol-based resin layer formed on a thermoplastic resin support through the production step A of the present invention, and FIG. 1(b) is a schematic view showing the polyvinyl alcohol-based resin layer on the thermoplastic resin support after the production step B of the present invention.

FIG. 2(c) is a schematic view showing the polyvinyl alcohol-based resin layer on the thermoplastic resin support after the dyeing step C of the present invention, and FIG. 2(d) is a schematic view similar to FIG. 2(c) but showing the state after the production step D of the present invention.

FIG. 3 is a schematic view showing the production steps B to D of the present invention.

FIG. 4 is a graph of absorbance versus polarization degree of a polarizer.

FIG. 5 is a graph of absorbance versus polarization degree of a dyed layer.

FIG. 6(a) is a schematic view of a production step in accordance with some embodiments, FIG. 6(b) is an enlarged sectional view showing a laminate of a film of PVA-based resin formed on a resin substrate which is prepared for use in the process step shown in FIG. 6(a), and FIG. 6(c) is an enlarged sectional view showing a laminate which is produced by the process shown in FIG. 6(a), and

FIG. 7 is a sectional view in an enlarged scale of a liquid crystal display device produced by using the laminate shown in FIG. 6(c).

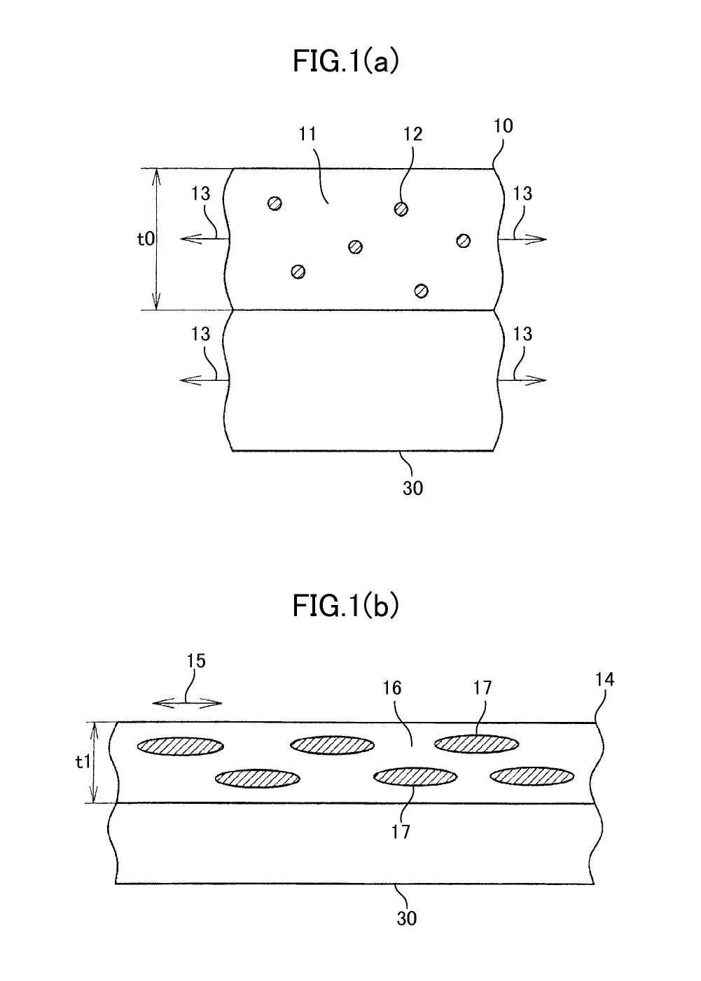

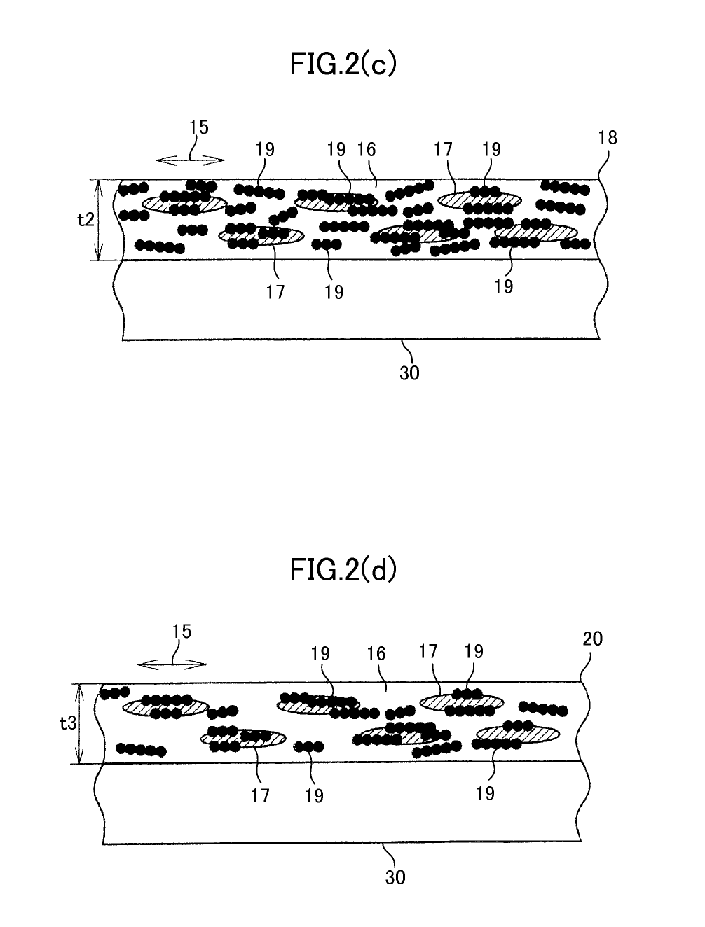

### DESCRIPTION OF THE PREFERRED EMBODIMENTS

### Production Method of the Present Invention

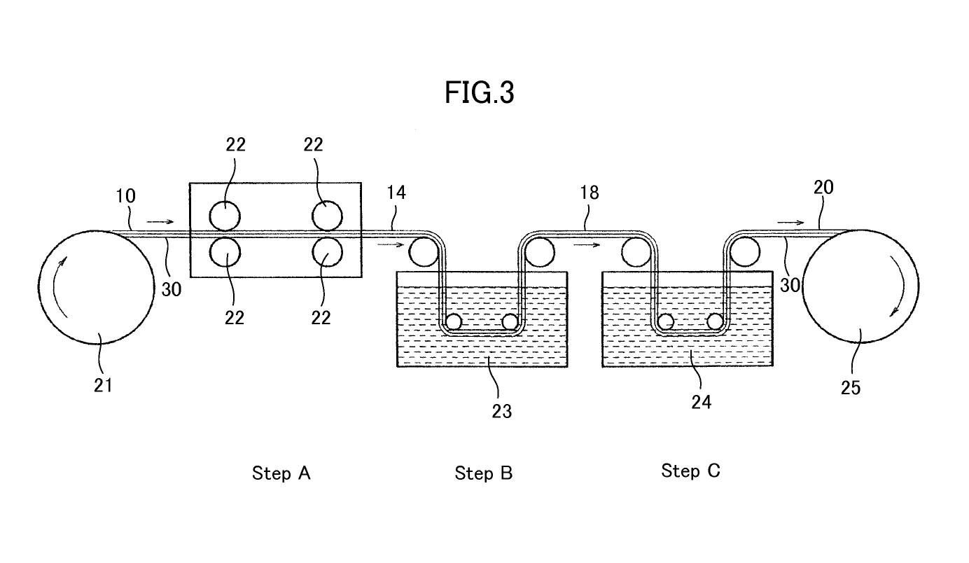

FIG. 3 is a schematic view showing sequential production steps B to D of the present invention. The production method of the present invention is a method for producing a polarizer 20 including a polyvinyl alcohol-based resin layer containing iodine, and laminated on an optically transparent thermoplastic resin layer 30. The term “laminated” used herein is intended to cover a polarizer 20 formed by a layer of polyvinyl alcohol-based resin coated on a support made of a thermoplastic resin, as well as a layer of polyvinyl alcohol-based resin separately formed from the thermoplastic resin layer and subsequently attached to the thermoplastic resin layer.

Although not shown in FIG. 3, a length of web of a support 30 of an optically transparent thermoplastic resin is prepared and a coated layer of polyvinyl alcohol-based resin is formed on the support to form a laminate of the polyvinyl alcohol-based resin layer and the thermoplastic resin layer. The laminate is then rolled to form a roll. With reference to FIG. 3, the untreated polyvinyl alcohol-based resin layer 10 formed on the support 30 is sequentially pulled out from the roll at a feed portion 21, together with the support 30, for a treatment.

In the step B, the polyvinyl alcohol-based resin layer 10 is stretched while passing through stretch rolls 22, together with the support 30, to form a stretched layer 14.

In the step C, the stretched layer 14 is immersed in a dyeing liquid 23 containing iodine to form a dyed layer 18. The dyed layer 18 has an absorbance A_{c}, which is determined from the tristimulus value Y, of 0.4 to 1.0 (T=40% to 10%).

In the step D, the dyed layer 18 is immersed in a decolorization liquid 24 (aqueous potassium iodide solution) thereby removing a part of iodine to form a polarizer 20. At this time, the absorbance A_{D} of the polarizer 20 decreases by 0.03 to 0.7 as compared with the absorbance A_{C} of the dyed layer 18 immediately after the step C, provided that the absorbance of the dyed layer is controlled so that it does not become less than 0.3.

The thus completed polarizer 20 is wound into a roll at a take-up portion 25.

The production method of the present invention may include the other steps as long as it includes the above-mentioned steps A, B, C and D in this order. Examples of the other steps include a step in which the dyed layer 18 is immersed in a crosslinking liquid (aqueous solution containing boric acid and, optionally, potassium iodide) between the step C and the step D thereby crosslinking the polyvinyl alcohol-based resin layer, and the step of drying the polarizer 20 obtained in the step D.

### [Step A]

As previously described, a length of web of a support 30 of an optically transparent thermoplastic resin is prepared and a coated layer of polyvinyl alcohol-based resin is formed on the support to form a laminate of the polyvinyl alcohol-based resin layer and the thermoplastic resin layer. The laminate is then taken up into a roll.

### [Step B]

The step B to be used in the present invention is a step of stretching the polyvinyl alcohol-based resin layer 10 to obtain the stretched layer 14.

The polyvinyl alcohol-based resin layer 10 to be used in the present invention is obtained by forming a polyvinyl alcohol-based resin into the form of a layer. The polyvinyl alcohol-based resin layer 10 is preferably formed on the support 30.

The polyvinyl alcohol-based resin is typically obtained by saponifying a polyvinyl acetate-based resin. The polyvinyl alcohol-based resin to be used in the present invention is, for example, polyvinyl alcohol or an ethylene-vinyl alcohol copolymer. The saponification degree of the polyvinyl alcohol-based resin to be used in the present invention is preferably from 85 mol % to 100 mol %, more preferably from 95 mol % to 100 mol %, and still more preferably from 98 mol % to 100 mol %, since water resistance is enhanced and it becomes possible to stretch at a high stretch ratio. The polymerization degree of the polyvinyl alcohol-based resin to be used in the present invention is preferably from 1,000 to 10,000 since it is possible to increase the polarization degree by increasing the amount of the polyiodine ion complex adsorbed to the crystallized portion 17.

It is possible to use, as a method of stretching the polyvinyl alcohol-based resin layer 10, any known stretching methods such as a roll stretching method and a tenter stretching method. The stretch ratio of the polyvinyl alcohol-based resin layer 10 is usually from 3 to 7 times larger than the original length.

Stretching of the polyvinyl alcohol-based resin layer 10 is preferably dry stretching. Dry stretching is stretching in air. Dry stretching is preferable than wet stretching since it can increase the crystallization degree. In this case, the stretching temperature is preferably from 80° C. to 170° C., and more preferably from 130° C. to 170° C. It is possible to accelerate the crystallization of a polymer chain in the polyvinyl alcohol-based resin layer 10 by setting the stretching temperature to 130° C. or higher. As a result, it is possible to increase the amount of the polyiodine ion complex adsorbed to the crystallized portion 17, and thus the polarization degree can be increased. It is also possible to prevent the crystallization of a polymer chain from excessively promoting and to shorten the dyeing time in the step C by setting the stretching temperature to 170° C. or lower. The polyvinyl alcohol-based resin layer 10 is preferably stretched so that the crystallization degree after stretching becomes 20% to 50%, and more preferably 32% to 50%. When the crystallization degree after stretching is from 20% to 50%, the amount of the polyiodine ion complex 19 adsorbed to the crystallized portion 17 increases, and thus the polarization degree can be increased.

The polyvinyl alcohol-based resin layer 10 may contain other additives, in addition to iodine. Examples of the other additives include surfactants, antioxidants, crosslinking agents and the like.

The polyvinyl alcohol-based resin layer 10 before stretching has a layer thickness t0 of usually 2 μm to 30 μm, and preferably 3 μm to 15 μm. Since the polyvinyl alcohol-based resin layer 10 has a thin layer thickness before stretching, in the case where it is difficult to stretch alone, the polyvinyl alcohol-based resin layer 10 is formed on the support 30 and the polyvinyl alcohol-based resin layer 10 is stretched, together with the support 30.

The stretched layer 14 has a layer thickness t1 of usually 0.4 μm to 7 μm, and preferably 0.6 μm to 5 μm. When the stretched layer 14 has a layer thickness t1 of 5 μm or less, it is possible to achieve the objective absorbance by dyeing within a short time.

### [Step C]

In the step C to be used in the present invention, the stretched layer 14 obtained in the step B is immersed in the dyeing liquid 23 containing iodine to obtain the dyed layer 18. The dyed layer 18 has an absorbance A_{C} of preferably 0.4 to 1.0 (T=40% to 10%). The dyed layer 18 has an absorbance A_{C} of more preferably 0.5 to 1.0 (T=31.6% to 10%). When the dyed layer 18 has an absorbance A_{C} of less than 0.4 (case where T is more than 40%), the polyiodine ion complex 19 may not be sometimes adsorbed sufficiently to the crystallized portion 17 of the polymer chain.

In the present invention, the absorbance A is calculated by the equation (1):

A=log₁₀(1/T) (1)

wherein the transmittance T is a value of the tristimulus value Y of the XYZ calorimetric system based on a two-degree view field in accordance with the JIS Z 8701 (1995). In the present specification, a value of the transmittance T is represented by a percentage assuming that it is 100% when T=1.

The absorbance A_{C}, which is determined from the tristimulus value Y, of the dyed layer 18 shall be within a defined range (preferably 0.4 to 1.0) immediately after the step C, but the absorbance may change afterwards.

The dyeing liquid 23 to be used in the present invention is usually an aqueous solution containing iodine and alkali iodide or ammonium iodide. In the dyeing liquid 23, alkali iodide or ammonium iodide is used so as to enhance solubility of iodine in water. The content of iodide of the dyeing liquid 23 is preferably from 1.1 parts by weight to 5 parts by weight based on 100 parts by weight of water. When potassium iodide is used as alkali iodide, the content of potassium iodide of the dyeing liquid 23 is preferably from 3 parts by weight to 30 parts by weight based on 100 parts by weight of water.

The temperature and immersion time of the dyeing liquid 23 are appropriately set so as to satisfy properties defined in the present invention depending on the concentration of the dyeing liquid 23 and the layer thickness of the stretched layer 14. The temperature of the dyeing liquid 23 is preferably from 20° C. to 40° C. The time of immersion in the dyeing liquid 23 is preferably from 60 seconds to 1,200 seconds.

### [Step D]

In the step D to be used in the present invention, a part of the polyiodine ion complex 19 is removed from the dyed layer 18 obtained in the step C to obtain the polarizer 20. The absorbance A_{D} of the polarizer 20 is controlled to the value which is 0.03 to 0.7 less than the absorbance A_{C} of the dyed layer 18 by removing the polyiodine ion complex 19. Provided that the absorbance A_{C} of the dyed layer is controlled so that it does not become less than 0.3.

The polarizer 20 has an absorbance A_{D}, which is determined from the tristimulus value Y, of preferably 0.3 to 0.4 (T=50% to 40%). In order to obtain the absorbance A_{D} within the above-mentioned range, the width ΔA (=A_{C}−A_{D}) of a decrease in absorbance in the step D is preferably from 0.03 to 0.7. The width ΔA of a decrease in absorbance in the step D is more preferably from 0.05 to 0.65. When the width ΔA of a decrease in absorbance is less than 0.03, a polarizer 20 having a high polarization degree may not be sometimes obtained.

When a part of the polyiodine ion complex 19 is removed from the dyed layer 18, for example, an aqueous solution of alkali iodide or ammonium iodide is used. The aqueous solution of alkali iodide or ammonium iodide used for this purpose is referred to as a decolorization liquid 24. The treatment of removing a part of the polyiodine ion complex 19 from the dyed layer 18 is referred to as decolorization. Decolorization may be carried out by immersing the dyed layer 18 in the decolorization liquid 24, or the decolorization liquid may be applied or sprayed on a surface of the dyed layer 18.

In the decolorization liquid 24, the polyiodine ion complex 19 is apt to elute from the dyed layer 18 by an action of iodine ions. Iodine ions are obtained from alkali iodides such as potassium iodide, sodium iodide, lithium iodide, magnesium iodide and calcium iodide. Alternatively, iodine ions are obtained from ammonium iodide. It is preferred that the concentration of iodine ions in the decolorization liquid 24 is sufficiently less than that of the dyeing liquid 23. When potassium iodide is used, the content of potassium iodide in the decolorization liquid 24 is preferably from 1 part by weight to 20 parts by weight based on 100 parts by weight of water.

The temperature and immersion time of the decolorization liquid 24 are appropriately set according to the layer thickness of the dyed layer 18. The temperature of the decolorization liquid 24 is preferably from 45° C. to 75° C. The immersion time in the decolorization liquid 24 is preferably from 20 seconds to 600 seconds.

### [Polarizer Obtained by the Production Method of the Present Invention]

The polarizer 20 obtained by the production method of the present invention includes a polyvinyl alcohol-based resin layer containing iodine. The above-mentioned polyvinyl alcohol-based resin layer is stretched and dyed, and thus polymer chains are oriented in a given direction. Iodine forms the polyiodine ion complex 19 such as I₃⁻ or I₅⁻ in the polyvinyl alcohol-based resin layer and exhibits absorption dichroism within a visible light range (wavelength 380 nm to 780 nm).

The film thickness t3 of the polarizer 20 is usually the same as the layer thickness t1 of the stretched layer 14 and is usually from 0.4 μm to 7 μm, and preferably from 0.6 μm to 5 μm.

According to the production method of the present invention, it is possible to adjust the polarization degree of the polarizer 20 having an absorbance A_{D} of about 0.37 (T=43%) and a film thickness t3 of 5 μm or less to 99.9% or more.

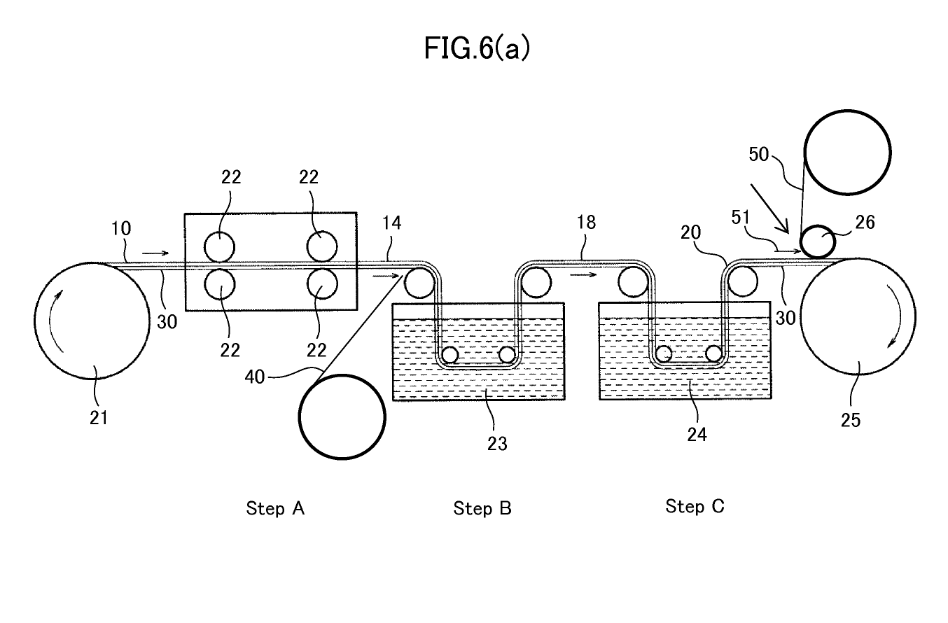

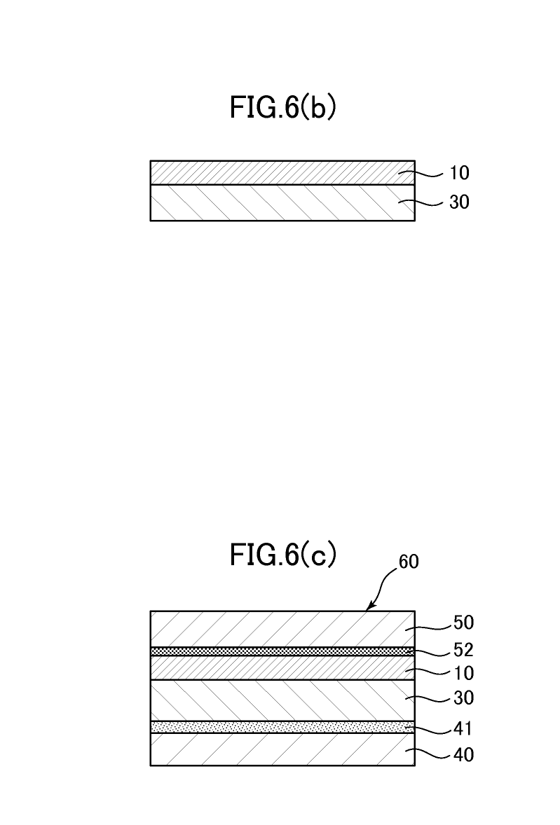

FIG. 6(a) shows a method in accordance with some embodiment of the present invention. Portions of the process shown in FIG. 6(a) corresponding to those in FIG. 3 are designated by the same reference numerals and detailed description will not be repeated. The process shown in FIG. 6(a) uses a laminate comprising a resin support 30 and a polyvinyl alcohol-based resin layer 10 as shown in FIG. 6(b). Prior to the stretching in the step (B), a masking film 40 is applied to the laminate at a side of the support 30.

The masking film 40 may be made of a film of a polyolefin such as polypropylene and polyethylene, or a film of polyester. The masking film 40 is applied to the exposed surface of the support 30 through an adhesive for the purpose of protecting the support 30 during the subsequent process steps so that the intended optical properties of the support may not be adversely affected due to inadvertent damage or scratching to which the support may possibly subjected. The adhesive attaching the masking film 40 to the support 30 may be selected from a group of adhesives which are stable in process conditions to which the adhesive may be subjected during the subsequent processes and which allows the masking film 40 to be easily removed from the support 30 at any desired time. Preferably, the adhesive does not remain on the support 30 after the masking film 40 is removed. Otherwise, the remaining adhesive on the support 30 may have adverse effect on the optical property of the support 30.

Preferably, the masking film 40 may be provided through a co-extrusion of polyolefin and ethylene vinyl alcohol resin. In such a case, the masking film may be adhesively attached to the support 30 utilizing the tacking power of the ethylene vinyl alcohol resin layer.

In an application where an optical compensation is required, a phase retardant film 50 may be attached through an adhesive to the exposed surface of the polyvinyl alcohol-based resin layer 10 as shown in FIG. 6(a). The phase retardant film 50 may be the one which may provide any required phase retardation. For example, in the case of a VA mode liquid crystal display, biaxial phase retardant film such as a negative B plate may preferably be used as the phase retardant film 50. The adhesive may be applied to the exposed surface of the polyvinyl alcohol-based resin layer 10 or to the surface of the phase retardant film 50 facing to the layer 10 as shown by an arrow 51 in FIG. 6(a). Alternatively, the polyvinyl alcohol-based resin layer 10 may be preliminarily applied with a coating of an adhesive at a side opposite to the support 30. Then in either of the cases, the film 50 may be pressed against the polyvinyl alcohol-based resin layer 10 by a pressing roll 26. The adhesive may be of any type, such as a thermosetting type, an energy radiation curable type, or self-adhesive type. Depending on the type of adhesive, an additional curing facility such as an oven or a UV radiation facility may be used.

The resultant laminate 60 thus obtained comprises, as shown in FIG. 6(c), a polyvinyl alcohol-based resin layer 10 and a support 30 with a masking film 40 adhesively attached to the support at a side opposite to the layer 10 through a layer of an adhesive 41, and a phase retardant film 50 adhesively attached to the layer 10 at a side opposite to the support 30 through a layer of an adhesive 52. The resultant laminate is then taken up into a take up roll 25. Optionally, there may be provided a tension adjusting mechanism in order to assure that the laminate is taken up with a uniform pressure distribution, the tension adjusting mechanism helps to ensure that the optical property of the support may not be adversely affected by a possible uneven pressure distribution in the taken up roll 25. As desired, edge portions of the laminate may be removed at the opposite edges so that any low quality edge portions may not be retained in the final product. Such low quality edge portion may possibly be produced during the curing process of the adhesive. In some embodiments, a mechanism may be provided for adjusting the edge portions of the laminate in the course of taking up into the roll 25 so that the laminate is prevented from being meandered.

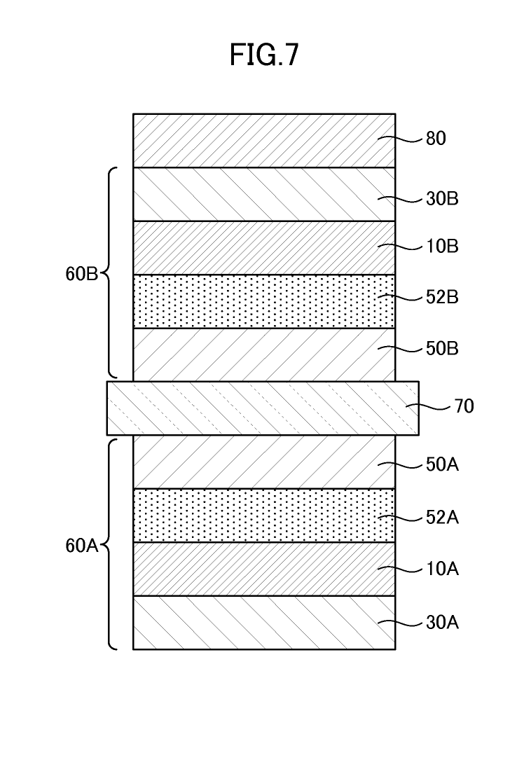

FIG. 7 shows an example of application of the laminate 60 into a liquid crystal display device. The liquid crystal display device comprises a liquid crystal (LC) cell 70 which may be of a VA mode. At one side of the LC cell 70, a laminate 60A is attached. The laminate 60A comprises a support 30A, a PVA-based polarizer 10A, a layer of an adhesive 52A and a phase retardant film 50A which are laminated together in this order. The laminate 60A is attached at the side of the phase retardant film 50A to the LC cell 70. Although not shown in FIG. 7, a back light system is disposed behind the support 30A. The support 30A is made of an optical film as described with reference to Example 1 of the US 2001/0004299 A1. Such an optical film has an anisotropic scattering polarization property.

At the side of the LC cell 70 opposite to the laminate 60A, there is provided a laminate 60B which comprises a support 30B, a PVA-based polarizer 10B, a layer of an adhesive 52B and a phase retardant film 50B which are laminated together in this order. The laminate 60B is attached to the LC cell 70 at the side of the phase retardant film 50B. The arrangement of the phase retardant films 50A and 50B shown in FIG. 7 can provide an improved compensation under a black display state to an incoming light which enters for example to the polarizer 10A in an oblique direction. More specifically, the phase retardant films function to modify such incoming light in such manner that the light can be more easily absorbed by the polarizer 10B, so that such incoming light does not pass to the viewing side of the display device.

In operation, the support 30A having an anisotropic scattering polarization functions in combination with the PVA-based polarizer 10A to reflect portions of the light from the back light which would otherwise be absorbed by the PVA-based polarizer 10A back toward the back light. The portions of the light reflected toward the back light are then reflected again toward the laminate 60A. Thus, support 30A helps to utilize the light from the back light in an effective way. The combination of the PVA-based polarizer 10B and the phase retardant film 50B provides a circular polarization system for preventing incoming light reflected at the LC cell 70 from being passed through the PVA-based polarizer 10B toward the observer's side. The support 30B functions as a protective layer. In this case, the support 30B is of an optically isotropic property. A surface treatment layer 80 may be provided on the support 30B. Although not shown in FIG. 7, a window may be provided outside the surface treatment layer 80.

### EXAMPLES

### Example 1

(1) An aqueous 7% by weight solution of polyvinyl alcohol was applied on a surface of a support made of a norbornene-based resin film having a film thickness of 150 μm (manufactured by JSR Corporation; product name: ARTON) to form a polyvinyl alcohol film. The polymerization degree of polyvinyl alcohol was 4,200, and the saponification degree thereof was 99% or more.

(2) The polyvinyl alcohol film and the support were dried at 80° C. for 8 minutes to form a polyvinyl alcohol layer having a layer thickness of 7 μm on the support to obtain a laminate of the polyvinyl alcohol layer and the support.

(3) Using a biaxial stretching machine manufactured by Iwamoto Seisakusho Co., Ltd., the laminate of the polyvinyl alcohol layer and the support was subjected to dry uniaxial stretching. The stretching temperature was 150° C. The stretch ratio was adjusted to the value which is 4.8 times larger than the original length. As a result of stretching, a laminate of the stretched layer and the support was obtained. The support is also stretched at the same ratio as that of the stretched layer.

(4) The laminate of the stretched layer and the support was immersed in a dyeing liquid of an aqueous solution containing iodine and potassium iodide thereby adsorbing and orienting a polyiodine ion complex to the stretched layer to obtain a laminate of the dyed layer and the support. The immersion time in the dyeing liquid was 600 seconds. The liquid temperature of the dyeing liquid was 25° C. The composition of the dyeing liquid was as follows: iodine:potassium iodide:water=1.1:7.8:100 in term of a weight ratio. Immediately after dyeing, the absorbance was 0.602.

(5) The laminate of the dyed layer and the support was immersed in a decolorization liquid containing potassium iodide and a part of the polyiodine ion complex of the dyed layer was removed. The composition of the decolorization liquid was as follows: water:potassium iodide=100:5.3 in terms of a weight ratio. The liquid temperature of the decolorization liquid was 60° C. The immersion time in the decolorization liquid was adjusted and five kinds of samples of the obtained polarizer having an absorbance of 0.357 to 0.377 were made.

(6) A laminate of the dyed layer partially decolorized and the support was immersed in a crosslinking liquid containing boric acid and potassium iodide. The composition of the crosslinking liquid was as follows: water:boric acid:potassium iodide=100:11.8:5.9 in terms of a weight ratio. The immersion time in the crosslinking liquid was 60 seconds. The liquid temperature of the crosslinking liquid was 60° C.

(7) A laminate of the dyed layer subjected to a crosslinking treatment and the support was dried at 60° C. for 120 seconds.

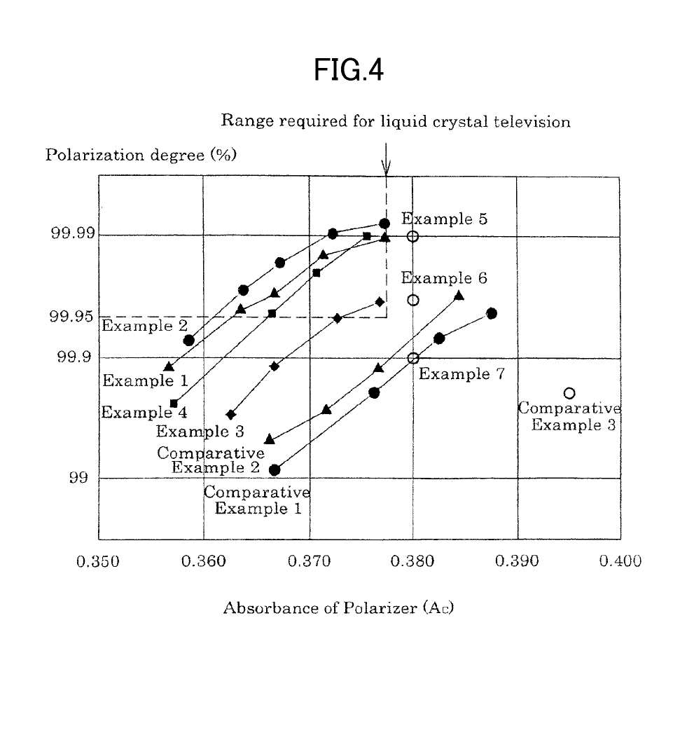

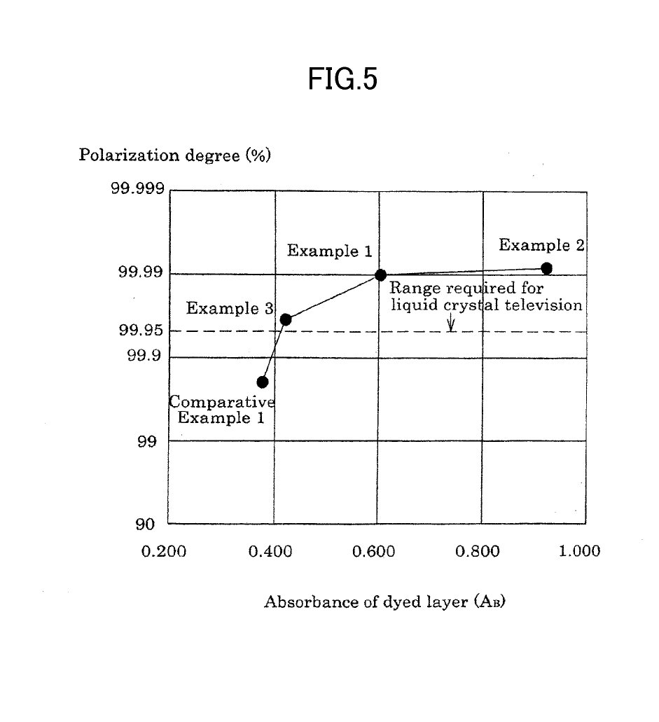

The laminate of a polarizer (film thickness of 2.9 μm) and the support was formed by the above-mentioned procedure. A graph of the absorbance (A_{D}) versus polarization degree of the polarizer is shown in FIG. 4. A graph of the absorbance (A_{C}) versus polarization degree of the dyed layer is shown in FIG. 5.

### Example 2

A laminate composed of a polarizer (thickness: 2.9 μm) and a support was formed in the same manner as in Example 1 except for the following points:

(1) The immersion time in the dyeing liquid was adjusted to set an absorbance at 0.921 immediately after dyeing.

(2) The immersion time in the decolorization liquid was adjusted to prepare five kinds of samples of the obtained polarizer having an absorbance of 0.359 to 0.377.

FIG. 4 is a graph of absorbance (A_{D}) versus polarization degree of a polarizer. And FIG. 5 is a graph of absorbance (A_{C}) versus polarization degree of a dyed layer.

### Example 3

A laminate composed of a polarizer (thickness: 2.9 μm) and a support was formed in the same manner as in Example 1 except for the following points:

(1) The immersion time in the dyeing liquid was adjusted to set an absorbance at 0.420 immediately after dyeing.

(2) The immersion time in the decolorization liquid was adjusted to prepare four kinds of samples of the obtained polarizer having an absorbance of 0.362 to 0.377.

FIG. 4 is a graph of absorbance (A_{D}) versus polarization degree of a polarizer. And FIG. 5 is a graph of absorbance (A_{C}) versus polarization degree of a dyed layer.

### Example 4

A laminate composed of a polarizer (thickness: 2.9 μm) and a support was formed in the same manner as in Example 1 except for the following points:

(1) The immersion time in the dyeing liquid was adjusted to set an absorbance at 0.959 immediately after dyeing.

(2) The immersion time in the decolorization liquid was adjusted to prepare four kinds of samples of the obtained polarizer having an absorbance of 0.357 to 0.376.

(3) The stretching temperature was 100° C. and the stretch ratio was 4.5 times larger than the original length.

FIG. 4 is a graph of absorbance (A_{D}) versus polarization degree of a polarizer

### Example 5

A laminate composed of a polarizer (thickness: 3.5 μm) and a support was formed in the same manner as in Example 1 except for the following points:

(1) An aqueous 5% by weight solution of polyvinyl alcohol was applied onto a surface of the support.

(2) The stretching temperature of the laminate was 140° C. and the stretch ratio was 4.0 larger than the original length.

(3) The composition of the dyeing liquid was as follows: iodine:potassium iodine:water=1:7:92 in terms of a weight ratio. The immersion time in the dyeing liquid was 300 seconds.

(4) The absorbance immediately after dyeing was 0.613.

(5) The content of potassium iodide of the decolorization liquid was as follows: water:potassium iodine=95:5 in terms of a weight ratio. The immersion time in the decolorization liquid was 30 seconds and the obtained polarizer had an absorbance of 0.380.

(6) The composition of the crosslinking liquid was as follows: water:boric acid:potassium iodine=85:1:0:5 in terms of a weight ratio.

FIG. 4 is a graph of absorbance (A_{D}) versus polarization degree of a polarizer.

### Example 6

A laminate composed of a polarizer (thickness: 3.5 μm) and a support was formed in the same manner as in Example 5 except for the following points:

(1) The immersion time in the dyeing liquid was 600 seconds. The absorbance immediately after dyeing was 0.417.

(2) The immersion time in the decolorization liquid was 2 seconds. The obtained polarizer had an absorbance of 0.380.

FIG. 4 is a graph of a graph of absorbance (A_{D}) versus polarization degree of a polarizer.

### Example 7

A laminate composed of a polarizer (thickness: 3.5 μm) and a support was formed in the same manner as in Example 5 except for the following points:

(1) An amorphous polyethylene terephthalate film with a thickness of 200 μm (manufactured by Mitsubishi Plastics, Inc., product name: Novaclear SG007) was used as a support.

(2) The stretching temperature was 110° C.

(3) The composition of the dyeing liquid was as flows: iodine:potassium iodine:water=0.2:1.4:98.4 in terms of a weight ratio.

(4) The immersion time in the dyeing liquid was 600 seconds. The absorbance immediately after dyeing was 0.577.

(5) The immersion time in the decolorization liquid was 8 seconds and the obtained polarizer had an absorbance of 0.380.

FIG. 4 is a graph of absorbance (A_{D}) versus polarization degree of a polarizer.

### Example 8

A laminate composed of a polarizer (thickness: 3.5 μm) and a support was formed in the same manner as in Example 7 except for the following points:

(1) An amorphous polyethylene terephthalate film with a thickness of 200 μm (manufactured by Mitsubishi Plastics, Inc., product name: Novaclear SG007) was coated at a side opposite to the side where polyvinyl alcohol film was to be coated with a water dispersive emulsion of urethane resin. The coating was then dried to form a film of urethane resin (Super Flex SF-420 available from Dai-Ichi Kogyo Seiyaku Co. Ltd. Japan; solid component of the emulsion has a refractive index of 1.49). The amorphous polyethylene terephthalate film having the film of urethane resin formed thereon was used as a support.

(2) The film of urethane had a thickness after stretching and dyeing of 90 nm.

The polarizer thus obtained had an absorbance (AC) of 0.380, and polarization degree of 99.91. Thus, the optical properties of this example ware substantially the same as those obtained in the Example 7. It was noted in the Example 8 that the film of the urethane resin provided an anti-reflection function, such that the transmission rate as measured on the laminate of the support and the polarizer was higher in the case of the Example 8 than the case of the Example 7 by approximately 1.5%. By using the support which has been provided for the purpose of forming a polarizer as an outermost member of a polarizing laminate which is to be assembled in a liquid crystal display device; it is possible to increase the brightness of the display device. Thus, a significant advantage can be accomplished by the arrangement.

### Example 9

A film of 70 μm thick was prepared in accordance with the method described with reference to the Example 1 in the US 2001/0004299 A1. The film thus prepared was used as a support and the steps (2) to (7) of the Example 1 was carried out to obtain a laminate comprising a PVA-based polarizing film and the support film which has an anisotropic scattering polarization property. Because of the existence of the support having an anisotropic scattering polarization property, the laminate thus obtained had an increased brightness as observed from the side of the PVA-based polarizing film.

### Comparative Example 1

A laminate composed of a polarizer (thickness: 2.9 μm) and a support was formed in the same manner as in Example 1 except for the following points:

(1) The immersion time in the dyeing liquid was adjusted to prepare four kinds of samples of the obtained polarizer having an absorbance of 0.367 to 0.387.

(2) No decolorization process was performed.

FIG. 4 is a graph of absorbance (A_{D}) versus polarization degree of a polarizer. And FIG. 5 is a graph of absorbance (A_{C}) versus polarization degree of a dyed layer.

### Comparative Example 2

A laminate composed of a polarizer (thickness: 2.9 μm) and a support was formed in the same manner as in Example 1 except for the following points:

(1) The immersion time in the dyeing liquid was adjusted to prepare four kinds of samples of the obtained polarizer having an absorbance of 0.367 to 0.384.

(2) No decolorization process was performed.

(3) The stretching temperature was 100° C. and the stretch ratio was 4.5 times larger than the original length.

FIG. 4 is a graph of absorbance (A_{D}) versus polarization degree of a polarizer.

### Comparative Example 3

A laminate composed of a polarizer (thickness: 3.5 μm) and a support was formed in the same manner as in Example 5 except for the following points:

(1) The composition of the dyeing liquid was as follows: iodine:potassium iodine:water=0.5:3.5:96.0.

(2) The immersion time in the dyeing liquid was 25 seconds. The absorbance immediately after dyeing was 0.395.

(3) No decolorization process was performed.

FIG. 4 is a graph of absorbance (A_{D}) versus polarization degree of a polarizer.

### [Evaluation]

FIG. 4 illustrates a graph of absorbance (A_{D}) versus polarizer degree of a polarizer.

(1) Comparing Examples 1 to 3, Example 2, Example 1, and Example 3 are arranged in descending order of reductions in polarization degree caused by decolorization. This is the descending order of absorption reduction caused by decolorization. The reduction of absorption in Example 2 was 0.544 to 0.562. And the reduction of absorption in Example 1 was 0.225 to 0.245. The reduction of absorption in Example 3 was 0.043 to 0.058. It is, therefore, presumed that the difference in polarization degree among Examples 1 to 3 is caused by reductions in absorption caused by decolorization.

(2) The polarization degree in Example 4 is higher than that of Example 3. The stretch conditions of Example 4 are 150° C. and 4.5 times larger than the original length. The stretch conditions in Example 3 are 150° C. and 4.8 times larger than the original length. The stretch conditions are disadvantageous in Example 4. On the other hand, the reduction of absorbance in Example 4 was 0.583 to 0.602. The reduction of absorbance in Example 3 was 0.043 to 0.058. This means that Example 4 is advantageous regarding reductions in absorbance. Since advantageous effects of the reduction in absorbance in Example 4 exceeded disadvantageous effects of the stretch conditions, it is presumed that the polarization degree of Example 4 is higher than that of Example 3.

(3) Stretch conditions in Example 5 are similar to the stretch conditions in Example 6. However, while a reduction in absorbance caused by decolorization is big (0.243) in Example 5, a reduction in absorbance is small (0.037) in Example 6. As a result, it is presumed that there is a difference between Example 5 and Example 6 in polarization degree because of the difference of reduction in absorbance.

(4) The stretching temperature (110° C.) in Example 7 is lower than the stretching temperature (140° C.) in Examples 5 and 6. Therefore, it is presumed to have a low polarization degree in Example 7.

(5) It is presumed that the reason why the polarization degree in Comparative Examples 1, 2, and 3 is low is that the reduction in absorbance caused by decolorization has not been achieved.

FIG. 5 illustrates a graph of the absorbance (A_{C},) versus polarization degree of a dyed layer. The stretch conditions in Examples and Comparative Example are both 150° C. and 4.8 times larger than the original length in this graph. Therefore, this graph simply shows effects of the reduction in absorbance caused by decolorization. This graph plots absorbance when the absorbance (A_{D}) of the polarization degree was set at 0.367. Thus, the higher absorbance of the dyed layer is, there is more reduction in absorbance caused by decolorization. Example 2, Example 1, and Example 3 are arranged in descending order of the more reduction in absorbance caused by decolorization. No decolorizing was performed in Comparative Example 1. As can be seen from the graph, the more the reduction in absorbance occurs, the higher the polarization degree is.

### [Measuring Method]

### [Absorbance]

An absorbance A was calculated from the following equation (1) by measuring a transmittance T of a sample using a spectrophotometer with integrating sphere (manufactured by MURAKAMI COLOR RESEARCH LABORATORY CO., LTD., product name: Dot-41):

A=log₁₀(1/T) (1)

wherein the transmittance T herein means a value of tristimulus value Y of the XYZ colorimetric systems based on a two-degree view field in accordance with the JIS Z 8701 (1995).

### [Polarization Degree]

A polarization degree was calculated from the following equation (2) by measuring a parallel transmittance H₀ and an orthogonal transmittance H₉₀ of a sample using a spectrophotometer with integrating sphere (manufactured by MURAKAMI COLOR RESEARCH LABORATORY CO., LTD., product name:Dot-41):

Polarization degree (%)={(H₀−H₉₀)/(H₀+H₉₀)}^{1/2}×100 (2)

Parallel transmittance means a transmittance measured when the two polarizers prepared in the same conditions are laminated so that the transmission axes may be parallel to each other. Orthogonal transmittance means a transmittance measured when the two polarizers prepared in the same manner are laminated such that transmittance axes thereof may be at right angles to each other. The parallel transmittance and the orthogonal transmittance are respectively a value Y of the tristimulus value of the XYZ colorimetric systems based on a two-degree view field in accordance with the JIS Z 8701 (1995).

It should be noted herein that in the case where the support of the optically transparent thermoplastic resin is of a material which may have influence on measurements of the transmission property and the polarizing degree, the measurements of the absorbance and the polarizing degree of the polarizer shall be conducted only with respect to the polarizer. In actual measurement, the support may be removed from the polarizer and the polarizer alone may be subjected to the measurement. If it is difficult to remove the support from the polarizer, the polarizer may be removed by dissolving the polarizer in a hot water or any other liquid and optical properties of the support may be measured. Then, the results of the measurements of the optical properties of the support may be subtracted through a mathematical calculation from the results of measurements on the laminate of the support and the polarizer to obtain optical properties of the polarizer.

### INDUSTRIAL APPLICABILITY

The polarizer of the present invention is preferably used for liquid crystal display devices such as liquid crystal television units, computer displays, car navigation systems, mobile phones, and game devices or the like.

### DESCRIPTION OF THE REFERENCE NUMERALS

10: polyvinyl alcohol-based resin layer; 11: amorphous portion; 12: crystallized portion; 13: arrow indicating a stretch direction; 14: stretched layer; 15: arrow indicating a stretch direction; 16: amorphous portion; 17: crystallized portion; 18: dyed layer; 19: polyiodine ion complex; 20: polarizer; 21: feed portion; 22: stretch roll; 23: dyeing liquid; 24: decolorization liquid; 25: take-up portion; 30: support

What is claimed is:

1. A method for producing a polarizer on an optically transparent thermoplastic resin support, the method comprising the steps of:
(A) forming a polyvinyl alcohol-based resin layer on the optically transparent thermoplastic resin support;
(B) stretching the polyvinyl alcohol-based resin layer together with the optically transparent thermoplastic resin support to obtain a laminate of a stretched polyvinyl alcohol-based resin layer and a stretched support;
(C) immersing the laminate of the stretched polyvinyl alcohol-based resin layer and the stretched support in a dyeing liquid containing iodine to obtain a dyed polyvinyl alcohol-based resin layer in which absorbance thereof determined from a tristimulus value Y is from 0.4 to 1.0 (transmittance T=40% to 10%); and
(D) removing a part of iodine adsorbed to the dyed polyvinyl alcohol-based resin layer so that the absorbance of the dyed layer decreases by 0.03 to 0.7, provided that the absorbance of the dyed layer is controlled so that it does not become less than 0.3.

2. The method in accordance with claim 1, wherein the stretched polyvinyl alcohol-based resin layer has a thickness of 0.4 to 7 μm.

3. The method in accordance with claim 1, wherein the optically transparent thermoplastic resin support is made of a material having after stretching at least one of a reflecting property, a light scattering property, a hue adjusting function, an antistatic function, an anisotropic scattering polarization property or an anti-blocking function.

4. The method in accordance with claim 3, wherein the optically transparent thermoplastic resin support is usable as an optical film, together with the polarizer formed of the polyvinyl alcohol-based resin layer after stretching.

5. The method in accordance with claim 3, wherein the optically transparent thermoplastic resin support comprises a material selected from a group including ester-based resin; cycloolefin-based resin; olefin-based resin; polyamide-based resin; polycarbonate-based resin; a copolymer resin thereof; and a blended polymer resin thereof.

6. A laminate of at least two optical films, comprising:
a polarizer comprising a stretched layer of polyvinyl alcohol-based resin including iodine adsorbed therein, and a support including a layer of an optically transparent resin;
wherein said layer of polyvinyl alcohol-based resin has a thickness of 0.4 to 7 μm and includes polymer chains oriented substantially in one direction, said polymer chain including a highly oriented crystallized portion; and
wherein said iodine adsorbed in said layer of polyvinyl alcohol-based resin is present in said layer of polyvinyl alcohol-based resin in the form of polyiodine ion complex adsorbed to the crystallized portion of said layer of polyvinyl alcohol-based resin to provide the polarizer with a dichroic property, the polarizer exhibits an absorbance of 0.359 to 0.380 and a polarization degree of 99.9% or higher.

7. A laminate in accordance with claim 6 wherein the polarizer exhibits an absorbance of 0.362 to 0.377 and has a polarization degree of 99.9% or higher.

8. A laminate in accordance with claim 6, wherein the support comprises a material having at least one of a reflecting property, a light scattering property, a hue adjusting function, an antistatic function, an anisotropic scattering polarization property and an anti-blocking function.

9. A laminate in accordance with claim 8, wherein the support comprises a material selected from a group including ester-based resin; cycloolefin-based resin; olefin-based resin; polyamide-based resin; polycarbonate-based resin; a copolymer resin thereof; or a blended polymer resin thereof.

10. A laminate of at least two optical films, comprising:
a polarizer comprising a stretched layer of polyvinyl alcohol-based resin including iodine adsorbed therein, and a support including a layer of an optically transparent resin;
wherein said layer of polyvinyl alcohol-based has a thickness of 0.4 to 7 μm and includes polymer chains oriented substantially in one direction, said polymer chain including a highly oriented crystallized portion; and
wherein said iodine adsorbed in said layer of polyvinyl alcohol-based resin is present in said layer of polyvinyl alcohol-based resin in the form of polyiodine ion complex adsorbed to the crystallized portion of said layer of polyvinyl alcohol-based resin to provide the polarizer with a dichroic property, whereby the polarizer exhibits an absorbance of 0.377 or less and a polarization degree of 99.95% or higher.

11. A laminate in accordance with claim 10 wherein the polarizer exhibits an absorbance of 0.362 to 0.377 and a polarization degree of 99.95% or higher.

12. A laminate in accordance with claim 10 wherein said polyiodine ion complex adsorbed to said crystallized portion of said polymer chain has a form of I₃⁻ or I₅⁻.

13. A laminate in accordance with claim 10, wherein the support comprises a material having at least one of a reflecting property, a light scattering property, a hue adjusting function, an antistatic function, an anisotropic scattering polarization property or an anti-blocking function.

14. A laminate in accordance with claim 8, wherein the support comprises a material selected from a group including ester-based resin; cycloolefin-based resin; olefin-based resin; polyamide-based resin; polycarbonate-based resin; a copolymer resin thereof; or a blended polymer resin thereof.

15. A method for producing an optical display device, the optical display, the method comprising the steps of:
(A) forming a polyvinyl alcohol-based resin layer on a support made of an optically transparent thermoplastic resin;
(B) stretching the polyvinyl alcohol-based resin layer together with the support to obtain a laminate of a stretched polyvinyl alcohol-based resin layer and a stretched support;
(C) immersing the laminate of the stretched polyvinyl alcohol-based resin layer and the stretched support in a dyeing liquid containing iodine to obtain a dyed polyvinyl alcohol-based resin layer in which absorbance thereof determined from a tristimulus value Y is from 0.4 to 1.0 (transmittance T=40% to 10%); and
(D) removing a part of iodine adsorbed to the dyed polyvinyl alcohol-based resin layer so that the absorbance of the dyed layer decreases by 0.03 to 0.7, provided that the absorbance of the dyed layer is controlled so that the absorbance remains at least 0.3;
assembling, after the step (D), the laminate in the display device by attaching the laminate to an optical display panel.
